(19) United States
(12) Patent Application Publication
(10) Pub. No.: US 2013/0163292 A1
(43) Pub. Date: Jun. 27, 2013

(54) MID-POINT VOLTAGE CONTROL

(71) Applicants: Duro Basic, Munchen (DE); Petar Jovan Grbovic, Ismaning (DE)

(72) Inventors: Duro Basic, Munchen (DE); Petar Jovan Grbovic, Ismaning (DE)

(73) Assignee: GENERAL ELECTRIC COMPANY, Schenectady, NY (US)

(21) Appl. No.: 13/334,691

(22) Filed: Dec. 22, 2011

(51) Int. Cl. H02M 5/40

(52) U.S. Cl. 363/34

(57) ABSTRACT

A midpoint voltage control system includes a power source, a generator coupled to the power source, a midpoint voltage controller coupled to the back-to-back converter configuration, a generator converter controller coupled to the midpoint power controller, a grid converter controller coupled to midpoint power controller, a first voltage converter coupled to the generator converter controller, the midpoint power controller and the generator, a second voltage converter coupled to the grid converter controller the midpoint power controller, the second voltage converter having a capacitor bank direct current (DC) bus midpoint and a transformer coupled to the second voltage converter and having a grid neutral midpoint, wherein the capacitor midpoint is interconnected to the grid neutral midpoint.

### BACKGROUND OF THE INVENTION

This invention is related to grid connected three-phase three-level neutral point connected (NPC) power converters, and more particularly to a neutral point clamped converter with midpoint voltage control via direct control of common mode current of the power converters applied in wind and solar power applications.

Voltage source pulse width modulated (PWM) power converters are implemented in many different power conversion applications such as, but not limited to variable speed drives, wind and solar converters, power supplies, uninterruptable power supplies (UPS), and static synchronous compensators (STATCOM). The converter topology is two-level or multi-level topology, such as a three-level neutral point clamped (NPC) topology. An NPC converter typically includes three phase legs and two series connected dc bus capacitors. Each phase leg is composed of four series connected switches, and each switch has parallel freewheeling diode. Two additional diodes, so-called clamping diodes are connected between the leg and the dc bus midpoint. A three-level NPC converter has many advantages, such as better utilization of the semiconductor switches and lower distortion of the output voltage. One of the main disadvantages is the need for balancing of the direct current (DC) bus midpoint voltage. Due to some non-idealities in operation of the power converter, the mid-point voltage has tendency to be unstable. To ensure stable operation, an additional circuit and/or control action is necessary. Fully active circuits include a DC bus midpoint that is not connected to the supply neutral point. The midpoint voltage is controlled acting on the converter modulation only. The advantage of these solutions is that no need for additional passive components. However, these solutions are facing serious limitations of balancing capability if the power factor is around zero. Passive and hybrid solutions have a DC bus midpoint that is connected to the supply neutral point. The connection can be direct or via an impedance source. The advantage of these solutions is that an effective capacitor midpoint voltage control can be achieved even at very low power factor including zero. However, the solution can be unstable, depending on the connection impedance. Also a disadvantage of the solution is that converter input inductor must not be a three-phase magnetically coupled inductor. The input inductor must be composed of three independent single-phase inductors. Alternatively if three-phase magnetically coupled inductor is used an additional inductor has to be inserted between the line and converter neutral points.

When the DC bus midpoint is connected to the supply neutral an additional active control of the neutral point current can be used. An average value of the neutral conductor current is controlled using an inner current control loop which adjusts the converter common mode voltage (via adding an offset into the converter modulation indexes m_{0L}). The capacitor midpoint voltage is balanced using an outer control loop which sets the neutral conductor current reference. The problem with the prior art is that the common mode voltage injection performed to control the neutral conductor current introduces a parasitic effect i.e. it is also coupled with a direct current injection into the capacitor midpoint. The sign and magnitude of this disturbing term depends on the converter active current value and it can lead to severe performance deteriorations or instabilities if left uncompensated. The control schemes presented in the prior art suffer from the fact that the midpoint voltage control performance strongly depends on the converter operating point due to parasitic current injection caused by the common mode control. The parasitic term changes sign when the power factor changes from cos φ=1 to cos φ=−1, where cos φ=1 indicates that active power flows from the generator side to the grid and cos φ=−1 indicates that active power flows from the grid to the generator. These changes make realization of the controller complicated.

### BRIEF DESCRIPTION OF THE INVENTION

According to one aspect of the invention, a midpoint voltage control system is described. The system includes a power source, a generator coupled to the power source, a midpoint voltage controller coupled to the back-to-back converter configuration, a generator converter controller coupled to the midpoint power controller, a grid converter controller coupled to midpoint power controller, a first voltage converter coupled to the generator converter controller, the midpoint power controller and the generator, a second voltage converter coupled to the grid converter controller the midpoint power controller, the second voltage converter having a capacitor bank direct current (DC) bus midpoint and a transformer coupled to the second voltage converter and having a grid neutral midpoint, wherein the capacitor midpoint is interconnected to the grid neutral midpoint.

According to another aspect of the invention, a midpoint voltage control system is described. The system includes a power source, a generator coupled to the power source, an alternating current to direct current (AC-DC) converter coupled to the generator, a direct current to alternating current (DC-AC) converter coupled to the AC-DC converter, via a first DC output, a DC bus midpoint output, and a second DC output, a transformer coupled to the DC-AC converter, and having a neutral point output, a midpoint power controller coupled to each of the first DC output, the DC bus midpoint output, and the second DC output, a generator converter controller coupled to the AC-DC converter and to the midpoint power controller, a grid converter controller coupled to the DC-AC converter and to the midpoint power controller and an inductor disposed between the DC bus midpoint and the neutral point of the transformer, wherein the inductor limits a common mode current from a common mode voltage at a third harmonic.

According to another aspect of the invention, a method for balancing a midpoint voltage of a neutral point clamped converter that includes a transformer and a back-back voltage converter configuration is described. The method includes controlling the midpoint voltage of the neutral point clamped converter by interconnecting a grid neutral midpoint of the transformer and a direct current bus midpoint of the back-back voltage converter configuration; and adjusting an inductance between the grid neutral midpoint of the transformer and the direct bus midpoint of the back-back voltage converter configuration, to limit a common mode current.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 shows high level control block diagram according to the proposed solution;

FIG. 2 illustrates further detail of FIG. 1;

FIG. 3 illustrates a block diagram of a transfer function between common mode voltage injection and capacitor midpoint current;

FIG. 4 illustrates a block diagram of a transfer function of an exemplary midpoint voltage control;

FIG. 5 shows an example of relative size and cost of the interconnection inductor versus the inductance and midpoint balancing current values; and

FIG. 6 illustrates a flow chart of a method for balancing a midpoint voltage of a neutral point connected power converter, in accordance with exemplary embodiments.

The detailed description explains embodiments of the invention, together with advantages and features, by way of example with reference to the drawings.

### DETAILED DESCRIPTION OF THE INVENTION

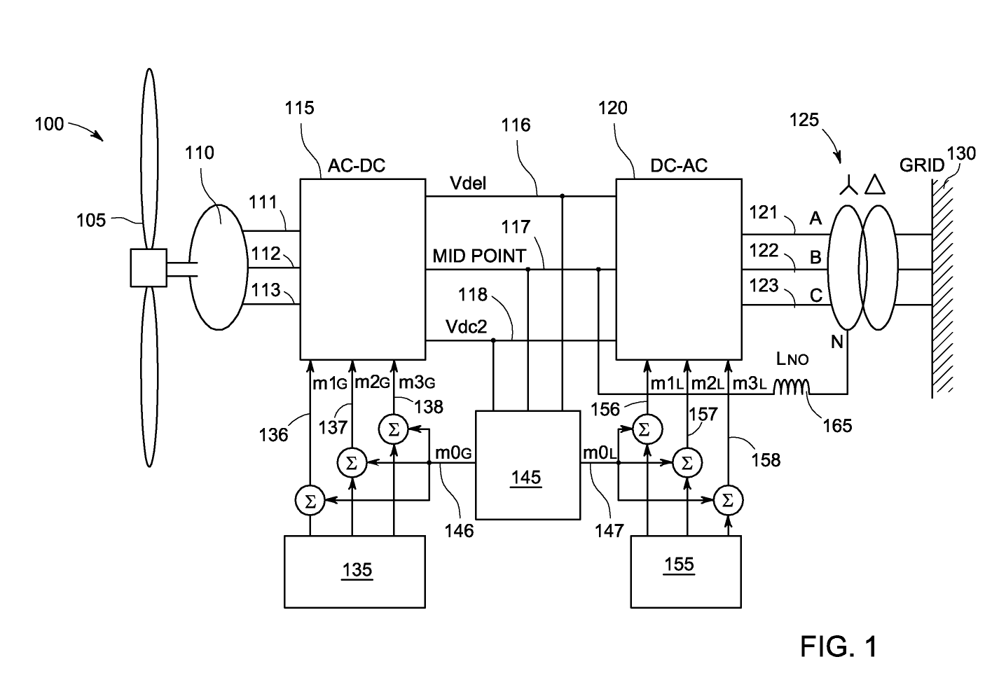

FIG. 1 illustrates an exemplary midpoint voltage control system 100. The system illustrates a wind power source. It will be appreciated that other power sources including but not limited to solar are contemplated in other exemplary embodiments. The system 100 includes a power source 105 (e.g., wind power), an alternating current (AC) generator 110 coupled to the power source 105. As further described herein the AC generator 110 can be a three phase generator having three inputs 111, 112, 113 into an AC-DC converter 115. The system 100 further includes a DC-AC converter 120 coupled to the AC-DC converter 115. The AC-DC converter 115 includes three outputs 116, 117, 118 for V_{dc1}, midpoint DC and V_{dc2} respectively, which are coupled to the DC-AC converter 120. The DC-AC converter 120 is coupled to a three phase transformer 125 that is coupled to a power grid 130. The DC-AC converter has outputs 121, 122, 123 that are coupled to the three-phase transformer 125. As described further herein, the DC midpoint is also coupled to the three phase transformer 125, thereby providing path for midpoint current and hence midpoint voltage control. An inductor 165 is coupled between the output 117 and the three phase transformer 125. The system 100 further includes a midpoint voltage controller 145 coupled to the outputs 116, 117, 118. The midpoint voltage controller 145 includes a first output 146 for a common mode modulation index command m_{0G} for the generator converter controller 135, and a second output 147 for a common mode modulation index command m_{0L} for the grid converter controller 155. The system 100 also includes a generator converter controller 135 coupled to the AC-DC converter 115 and the midpoint voltage controller 145. The system 100 further includes a grid converter controller 155 coupled to the DC-AC converter 120 and the midpoint voltage controller 145. In exemplary embodiments, the generator converter controller 135 and the midpoint voltage controller 140 generate modulation command (indexes) m_{1G}, m_{2G}, m_{3G} respectively input into the AC-DC converter 115 via input lines 136, 137, 138. The grid converter controller 155 and the midpoint voltage controller 140 generate modulation indexes m_{1L}, m_{2L}, m_{3L} respectively input into the DC-AC converter 120 via input lines 156, 157, 158.

In exemplary embodiments, the back to back converters, that is, the AC-DC converter 115 and the DC-AC converter 120 are respectively controlled by the neutral point, N, of the three phase transformer 125 and the DC midpoint. In addition, value of the inductor 164 coupled between the three phase transformer 125 and the DC bus midpoint is selected as described herein.

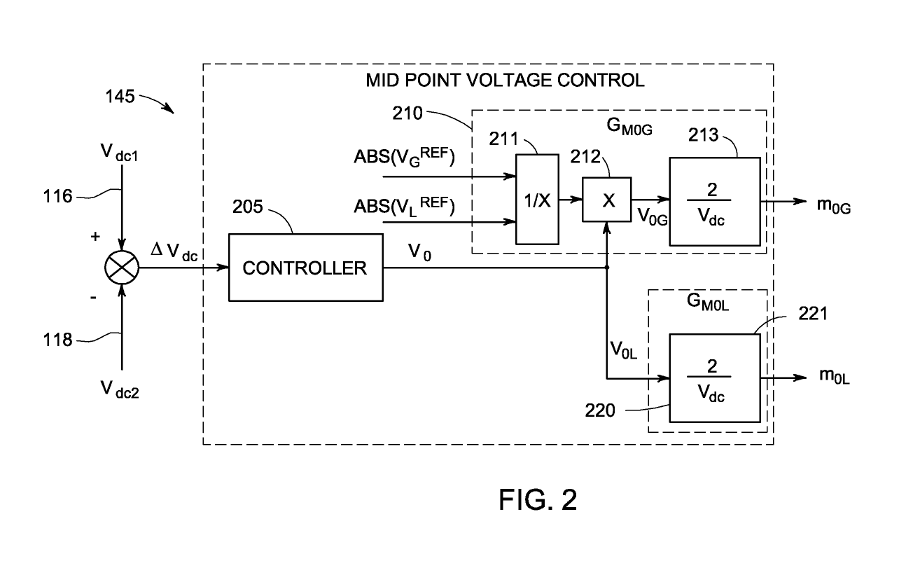

FIG. 2 illustrates additional detail of the midpoint voltage controller 145 of FIG. 1. The midpoint voltage controller 145 can include an internal controller 205 coupled to a generator scaling factor block G_{M0G} 210 and a grid scaling factor block G_{M0L} 220. In exemplary embodiments, the midpoint voltage control can be any control type including, but not limited to a proportional (P) or proportional/integral (PI) controller. The generator scaling factor block G_{M0G} 210 includes an additional scaling block 211 that receives a generator fundamental voltage reference ABS (V_{G}^{REF}) and a grid fundamental voltage reference ABS (V_{L}^{REF}). The output of the scaling block 211 is coupled to a node 212 that outputs a common mode generator voltage V_{0G} and a common mode grid voltage V_{0L}. Both the common mode generator voltage V_{0G} and a common mode grid voltage V_{0L} are respectively input into nodes 213, 221 that scale the common mode voltage commands by the inverse of half of the total dc voltage (V_{dc}=V_{dc1}+V_{dc2}). The nodes 213, 221 then generate the respective common mode modulation index command m_{0G} for the generator converter controller 135, and common mode modulation index command m_{0L} for the grid converter controller 155.

In exemplary embodiments, the controller 205 receives the midpoint voltage error, which is represented by, ΔV_{dc}=V_{dc1}−V_{dc2} as the input signal, while the controller output is the line side converter common mode voltage command V₀. The common mode voltage V₀ is then modified to the line (grid) and generator side converters modulation indexes via scaling factors G_{M0L} and G_{M0G}. The G_{M0G} scaling factor is designed to scale the common mode voltage V₀ in order to reduce or eliminate influence of the system operating mode on the controller parameters. Outputs of the scaling factor blocks are m_{0L} and m_{0G}, where m_{0L} is the common mode modulation index command for the grid side converter, while m_{0G} is common mode modulation index command for the generator side. The two additional inputs to the scaling block G_{M0G} are ABS(V_{G}^{Ref}) and ABS(V_{L}^{REF}), where ABS(V_{G}^{Ref}) is magnitude of the generator side fundamental voltage reference, while ABS(V_{L}^{REF}) is magnitude of the line side fundamental voltage reference.

As described herein, the grid neutral point, N, and the DC bus midpoint are coupled via an inductor 165 (L_{N0}). The inductor 165 limits common mode current. The common mode current is caused by common mode voltage, where the common mode voltage is the voltage at switching frequency, the voltage at third harmonic and common mode voltage when discontinuous modulation scheme is used. The value of the inductance is computed for allowed common mode current. However, the inductor size and cost therefore strongly depends on the inductance. As such, the inductor value is selected as described herein in order to meet this dependence.

In exemplary embodiments, each three-level NPC converter provides a three step output voltage by switching between the + and −DC bus rails and capacitor midpoint. The intermediate voltage level (midpoint) is created by a DC bus capacitor voltage divider (i.e. by a DC bus split into two capacitors banks connected in series). In exemplary embodiments, the two capacitor banks share equally the total DC bus voltage. The capacitor voltage balance is affected by average value of the capacitor midpoint current. In exemplary embodiments, the midpoint voltage is controlled by linking the capacitor midpoint to the grid neutral midpoint, N, via a neutral conductor and to control the grid converter common mode voltage and hence neutral conductor current. This configuration balances the capacitor voltage via neutral current control combined with additional coordinated common mode voltage of a converter in the back-back topology. However the common mode voltage injection (injected to control the neutral conductor current) creates a parasitic effect which results in a net average current injection into the midpoint which is proportional to the active component of the converter current and its power factor. Effect of this parasitic current injection term is significant and can lead to the midpoint voltage control instability. Compensation of this parasitic term is possible in multi converter topologies where two or more converters are connected to same dc bus (one simplest example is two converter back to back converter topology). As such, it is possible to compensate this parasitic injection term if the midpoint voltage controller output is appropriately scaled and fed to all interconnected converter outputs.

In exemplary embodiments, the DC bus midpoint and grid neutral midpoint are interconnected such that sufficient common mode path inductance is provided to limit the common mode switching ripple and circulating currents due to the 3^{rd} harmonic injection. The selection of the inductor value is described herein.

In exemplary embodiments, as described herein, the systems and methods interconnect the grid neutral midpoint and the DC bus midpoint as now described. The common mode current i₀ flows from the inductor 165 to the output 117. The common mode current i₀ is driven by the common mode voltage created by the DC-AC converter 120 and the common mode current i₀ value depends on the common mode current path parameters (i.e., equivalent inductance L₀ and resistance R₀ of the common mode path. The common mode path can include additional impedance inserted between the three phase transformer 125 and converter neutral points (i.e., the inductor 165), and can be given as:

$${L}_{0} \frac{d {i}_{0}}{d t} = {v}_{0} - {R}_{0} {i}_{0} \qquad ( 1 )$$

The capacitor voltage imbalance depends on an average of difference of the capacitor currents in the DC-AC converter 120. This current difference is equal to the midpoint current i_{MP}:

$$\begin{matrix}C \frac{d ( {v}_{d c 1} - {v}_{d c 2} )}{d t} = {i}_{c 1} - {i}_{c 2} \\ and & ( 2 ) \\ C \frac{d Δ {v}_{d c}}{d t} = {i}_{MP} & ( 3 )\end{matrix}$$

Further, current flowing into capacitor midpoint and affecting the capacitor voltage imbalance includes one component one flowing through the neutral conductor i₀ (e.g., the inductor 165) and one parasitic created by the inverter i_{MPinv} of the DC-AC converter:

i_{MP}=i_{MPinv}−i₀ (4)

The current component injected by the inverter i_{MPinv} depends on the phase currents and average dwelling time of the switches in the midpoint. The average time for each switch is defined by its modulation index (m) and depends on the fundamental component modulation depth (M_{L}), the third harmonic injection magnitude (m_{3L}) and common mode m_{0L} injection (injected to control the neutral conductor current):

$$\begin{matrix}{m}_{1 L} = {M}_{L} sin θ + {m}_{3 L} sin 3 θ + {m}_{0 L} & ( 5 ) \\ {m}_{2 L} = {M}_{L} sin ( θ - \frac{2 π}{3} ) + {m}_{3 L} sin 3 θ + {m}_{0 L} & ( 6 ) \\ {m}_{3 L} = {M}_{L} sin ( θ + \frac{2 π}{3} ) + {m}_{3 L} sin 3 θ + {m}_{0 L} & ( 7 ) \\ {i}_{MPinv} = ( 1 - \vert {m}_{1 L} \vert ) {i}_{1 L} + ( 1 - \vert {m}_{2 L} \vert ) {i}_{2 L} + ( 1 - \vert {m}_{3 L} \vert ) {i}_{3 L} & ( 8 )\end{matrix}$$

The modulation depths and indexes are obtained by dividing the voltage references by V_{dc}/2 where V_{dc}=V_{dc1}+Vd_{c2} is total DC bus voltage. Thus, the voltage references and modulation indexes can be used interchangeably if the scaling factor of V_{dc}/2 is taken into account. For example, the common mode voltage injection of V_{oL} modifies modulation index of each phase for amount m_{oL}=V_{oL}/(V_{dc}/2)

The average current component created by the inverter has two components: a term proportional to the neutral conductor current Iₒ and a parasitic term which couples the control common mode voltage with the converter current I_{L}:

$${I}_{MPinv} = - \frac{6}{π} ( {I}_{L} cos {ϕ}_{L} + \frac{1}{3} {I}_{3 L} cos {ϕ}_{3 L} ) {m}_{0 L} + {I}_{0} - \frac{2}{π} ( {M}_{L} + \frac{1}{3} {m}_{3 L} ) {I}_{0} \qquad ( 9 )$$

where the third harmonic common mode voltage m_{3L} for the standard carrier based space-vector references is typically:

$${m}_{3 L} = \frac{2}{{π}^{2}} {M}_{L} \qquad ( 10 )$$

The total capacitor midpoint current is:

$${I}_{MP} = - ( \frac{6}{π} {I}_{L} cos {ϕ}_{L} {m}_{oL} + \frac{2}{π} ( 1 + \frac{2}{3 {π}^{2}} ) {M}_{L} {I}_{0} ) \qquad ( 11 )$$

The third harmonic contribution is taken into account via a constant k (k close to unity):

$${I}_{MP} = - ( k \frac{2}{π} {M}_{L} {I}_{0} + \frac{6}{π} {I}_{L} cos {ϕ}_{L} {m}_{oL} ) \qquad ( 12 )$$

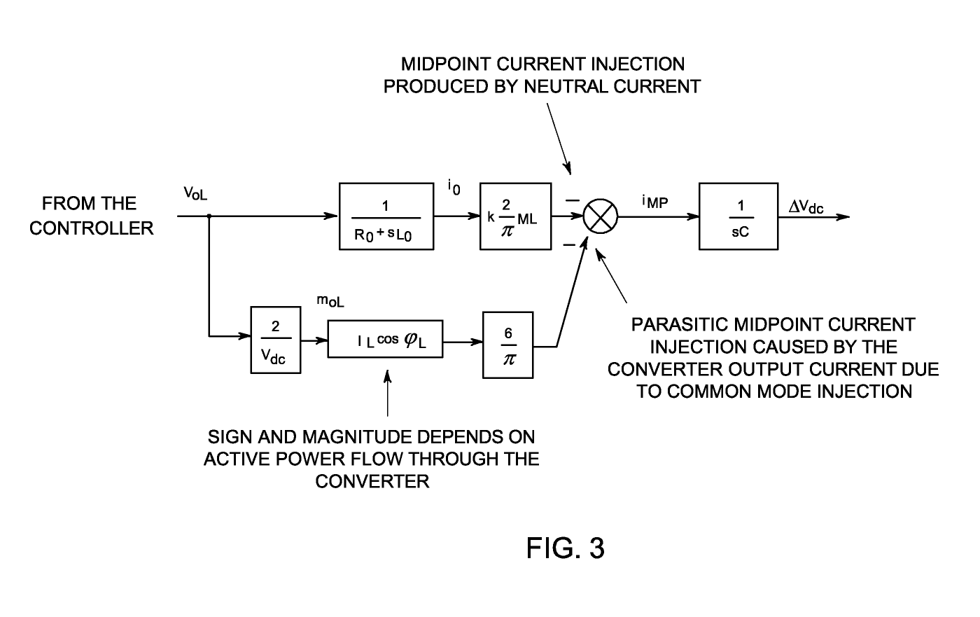

The equivalent block diagram of the capacitor imbalance dynamics reflecting this relationship is shown in FIG. 3. Theoretically, the capacitor midpoint current injection should be controlled exclusively by the neutral conductor current I₀ (first term in Eq. (12)). The second term in Eq. (12), I_{L} cos φ_{L}, introduces additional path which translates the common mode voltage control (i.e. m_{oL}) directly into a current injection with the gain and sign strongly dependent on the operational conditions (converter/load current and power factor).

In exemplary embodiments, the systems and methods described herein attain controllability of the midpoint voltage control via the neutral conductor current control by removing the parasitic load (converter) current dependent injection. The back to back orientation of the AC-DC converter 115 and the DC-AC converter 120 achieves this goal. As the power balance in the back-back converter configuration is satisfied, the following equation is valid (where M_{G}, I_{G}, φ_{G} are modulation depth, current and power factor of the generator size converter):

M_{L}I_{L} cos φ_{L}+M_{G}I_{G} cos φ_{G}≈0 (13)

As such, if a common mode voltage m_{oG} is injected into the voltage references of the AC-DC converter 115, which is proportional to the common mode voltage injected into the voltage references of the DC-AC converter 124, the coupling terms related to the load current are compensated was follows:

$${m}_{oG} = {m}_{oL} \frac{{M}_{G}}{{M}_{L}} = {m}_{oL} \frac{\vert {V}_{G}^{Ref} \vert}{\vert {V}_{L}^{Ref} \vert} \qquad ( 14 )$$

The parasitic current injection into the capacitor midpoint caused by converter load current can be compensated by an identical current injection but with opposite sign created by the AC-DC converter 115. As the AC-DC converter 115 is not connected to the neutral point, N, this injection is not affecting the neutral conductor current. It will be appreciated that any number of converters in any back to back converter topology is contemplated in other exemplary embodiments.

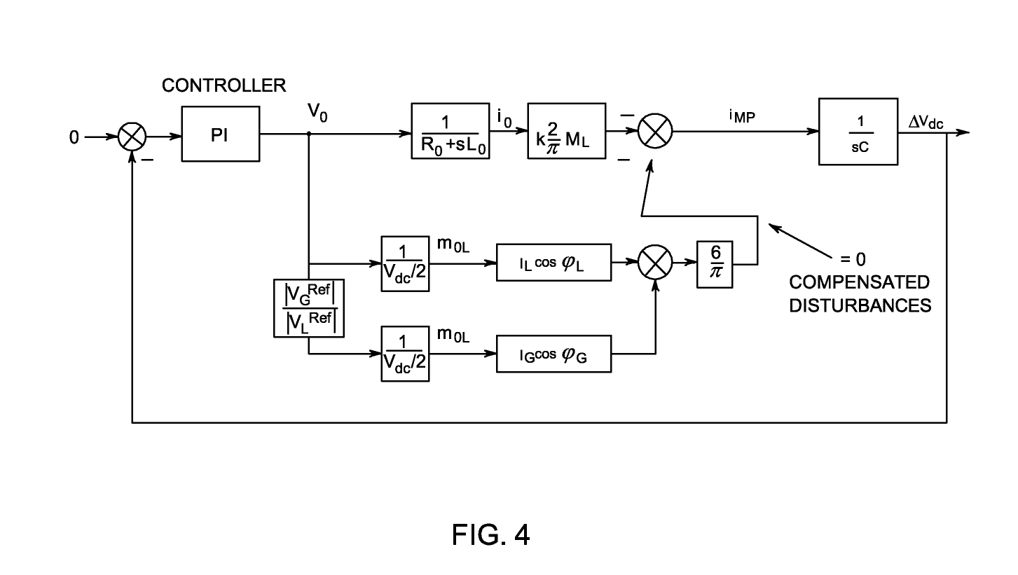

After the parasitic injections are compensated, the model can be reduced to a transfer function as illustrated in FIG. 4. As such, any controller 205 type (e.g., P or PI type) can be synthesized to attain robust midpoint voltage control regardless of the converter operational conditions.

In exemplary embodiments, the inductor 165 is also selected in order to reduce the inductor cost and size. The inductor 165 is connected between the grid neutral midpoint and the DC bus midpoint. The inductor 165 limits common mode current that flows from the neutral N to the capacitor midpoint (i.e., output 117). The common mode current is caused by the common mode voltage, which has three main components: 1) Common mode voltage at switching frequency; 2) Common mode voltage caused by third harmonic injection; and 3) Common mode voltage caused by discontinuous modulation strategy. The third harmonic modulation is a conventional technique that can be implemented to extend voltage range of the DC-AC converter 120. The third harmonic modulation index is generally in range of 15 to 20% of nominal fundamental modulation index, but it could be set at zero. Common mode voltage caused by discontinuous modulation strategy is also a conventional technique that can be implemented to reduce switching losses of the switching devices of the DC-AC converter 120.

Selection of the inductance value of the inductor 165 depends on the common mode current that can be allowed. Usually, the common mode current at the switching frequency is around 1% of the converter rated current, while the common mode current at third harmonic frequency can be in range of 10 to 20% of the converter nominal current. The same applies in case of discontinuous modulation. However, the inductor size strongly depends on the inductance and the common mode current. Generally, the inductor relative size and therefore its cost can be expressed in the following form

V≅L₀I_{0(PEAK)}I_{0(RMS)} (15)

where L₀ is the inductance, I_{0(PEAK)} is the common mode peak current and I_{0(RMS)} is the common mode RMS current.

The interconnection inductor RMS current is approximately:

$${I}_{0 ( RM S )} ≅ \sqrt{{I}_{0 ave}^{2} + {( \frac{{V}_{d c}}{6 \sqrt{2} ω {L}_{N 0}} {m}_{3 L} )}^{2} + {( \frac{{V}_{d c}}{24 {f}_{SW} {L}_{N 0}} )}^{2} \frac{1}{3}} . \qquad ( 16 )$$

The interconnection inductor peak current is approximately:

$${I}_{0 ( PEAK )} ≅ {I}_{0 ave} + \sqrt{2} ( \frac{Vdc}{6 \sqrt{2} ω {L}_{N 0}} {m}_{3 L} ) + ( \frac{Vdc}{24 {f}_{SW} {L}_{N 0}} ) .$$

The

$$C \frac{d Δ {v}_{d c}}{d t} = {i}_{MP}$$

current level depends on the maximum midpoint imbalance current which has to be injected to stabilise the midpoint voltage. The

$$C \frac{d Δ {v}_{d c}}{d t} = {i}_{MP}$$

current level depends on the internal converter asymmetries or/and line side voltage even distortion level and is below 1-3% % of the converter nominal current.

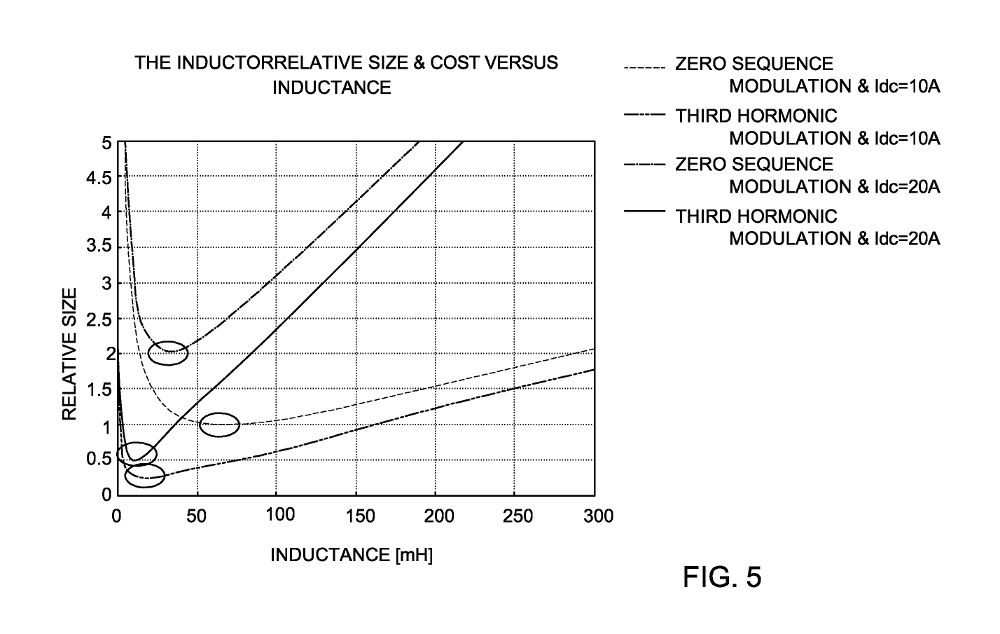

From equations (15)-(17), one can compute the inductor size versus inductance. FIG. 5 illustrates a graph of relative size and cost of the inductor 165 versus inductance. The inductor 165 can be reduced if a particular inductance is selected. For example, if the DC component of the common mode current is 20 A and the third harmonic modulation is applied; from the graph of FIG. 5 the selected inductance is approximately 10 mH.

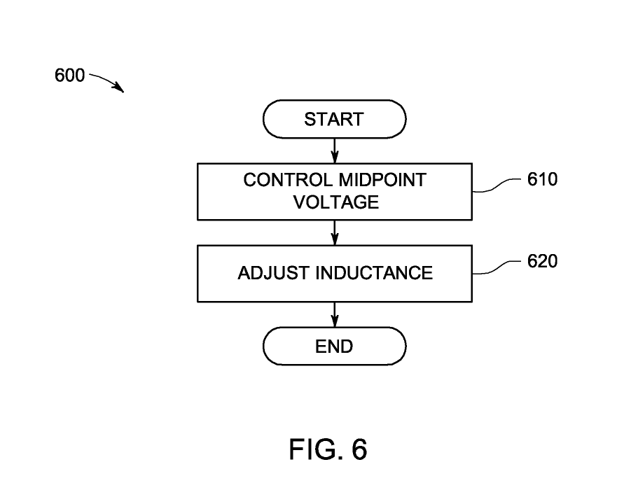

FIG. 6 illustrates a flow chart of a method 600 for balancing a midpoint voltage of an NPC power converter in accordance with exemplary embodiments. As described herein, at block 610, the midpoint voltage is controlled by interconnecting the grid neutral midpoint of the transformer 125 and a DC bus midpoint of the AC-DC converter 115 and the DC-AC converter 120. At block 620, the inductor 165 is adjusted between the grid neutral midpoint of the transformer 125 and a DC bus midpoint of the AC-DC converter 115 and the DC-AC converter 120. The inductance is adjusted to limit the common mode current as described herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A midpoint voltage control system, comprising:
a power source;
a generator coupled to the power source;
a midpoint voltage controller coupled to the back-to-back converter configuration;
a generator converter controller coupled to the midpoint power controller;
a grid converter controller coupled to midpoint power controller;
a first voltage converter coupled to the generator converter controller, the midpoint power controller and the generator;
a second voltage converter coupled to the grid converter controller the midpoint power controller, the second voltage converter having a capacitor bank direct current (DC) bus midpoint; and
a transformer coupled to the second voltage converter and having a grid neutral midpoint,
wherein the capacitor midpoint is interconnected to the grid neutral midpoint.

2. The system as claimed in claim 1 further comprising an inductor disposed between the DC bus midpoint output and the grid neutral midpoint of the transformer.

3. The system as claimed in claim 1 wherein the midpoint voltage controller is configured to generate a common mode modulation index command for the grid converter controller.

4. The system as claimed in claim 3 wherein the midpoint voltage controller is configured to generate a common mode modulation index command for the generator converter controller.

5. The system as claimed in claim 1 wherein the midpoint power controller comprises a proportional/integral controller.

6. The system as claimed in claim 1 further comprising a power grid coupled to the transformer.

7. The system as claimed in claim 1 wherein the first and second voltage converters are configured to compensate internal parasitic terms in response to a scaled common mode voltage of the second voltage converter.

8. A midpoint voltage control system, comprising:
a power source;
a generator coupled to the power source;
an alternating current to direct current (AC-DC) converter coupled to the generator;
a direct current to alternating current (DC-AC) converter coupled to the AC-DC converter, via a first DC output, a DC bus midpoint output, and a second DC output;
a transformer coupled to the DC-AC converter, and having a neutral point output;
a midpoint power controller coupled to each of the first DC output, the DC bus midpoint output, and the second DC output;
a generator converter controller coupled to the AC-DC converter and to the midpoint power controller;
a grid converter controller coupled to the DC-AC converter and to the midpoint power controller; and
an inductor disposed between the DC bus midpoint and the neutral point of the transformer, wherein the inductor limits a common mode current from a common mode voltage at a third harmonic.

9. The system as claimed in claim 8 wherein the transformer includes a grid neutral midpoint.

10. The system as claimed in claim 8 wherein the midpoint voltage controller is configured to generate a common mode modulation index command for the grid converter controller.

11. The system as claimed in claim 10 wherein the midpoint voltage controller is configured to generate a common mode modulation index command for the generator converter controller.

12. The system as claimed in claim 8 wherein the midpoint voltage controller is configured to receive a midpoint voltage error.

13. The system as claimed in claim 12 wherein the midpoint voltage error is the difference between a voltage value of the first DC output and a voltage value of the second DC output.

14. The system as claimed in claim 13 wherein the midpoint power controller is configured to generate scaling factor to control the generator converter controller common mode modulation index command based on the grid converter controller common mode command.

15. The system as claimed in claim 8 further comprising a power grid coupled to the transformer.

16. The system as claimed in claim 8 wherein the inductor is selected to increase a common mode current to a predetermined value.

17. A method for balancing a midpoint voltage of a neutral point clamped converter (NPC) that includes a transformer and a back-back voltage converter configuration, the method comprising:
controlling the midpoint voltage of the NPC by interconnecting a grid neutral midpoint of the transformer and a direct current (DC) bus midpoint of the back-back voltage converter configuration; and
adjusting an inductance between the grid neutral midpoint of the transformer and the DC bus midpoint of the back-back voltage converter configuration, to limit a common mode current.

18. The method as claimed in claim 17 wherein the back-back converter configuration includes a capacitor bank having a capacitor midpoint voltage.

19. The method as claimed in claim 18 further comprising linking the capacitor midpoint voltage to the grid neutral midpoint.

20. The method as claimed in claim 19 further comprising compensating a parasitic injection term by scaling the midpoint voltage.
